(19) United States
(12) Patent Application Publication
(10) Pub. No.: US 2024/0273378 A1
(43) Pub. Date: Aug. 15, 2024

(54) SYSTEMS AND METHODS FOR LEARNING AT AN EDGE DEVICE

(71) Applicant: ADOBE INC., SAN JOSE, CA (US)

(72) Inventors: Saayan Mitra, San Jose, CA (US); Arash Givchi, Philadelphia, PA (US); Xiang Chen, San Jose, CA (US); Somdeb Sarkhel, San Jose, CA (US); Ryan A. Rossi, San Jose, CA (US); Zhao Song, Seattle, WA (US)

(21) Appl. No.: 18/163,624

(22) Filed: Feb. 2, 2023

(51) Int. Cl. G06N 3/098; G06N 3/092

(52) U.S. Cl. CPC G06N 3/098; G06N 3/092

(57) ABSTRACT

Systems and methods for distributed machine learning are provided. According to one aspect, a method for distributed machine learning includes obtaining, by an edge device, a static machine learning model from a hub device, computing, by the edge device, an objective function for a dynamic machine learning model based on a relationship between the dynamic machine learning model and the static machine learning model, and updating, by the edge device, the dynamic machine learning model based on the objective function.

### BACKGROUND

The following relates generally to machine learning, and more specifically to distributed machine learning. Machine learning algorithms build a model based on sample data, known as training data, to make predictions or decisions without being explicitly programmed to do so. A distributed system is a system whose components are located on different networked computers, which communicate and coordinate their actions by passing messages to one another from any system. An example of a distributed system includes a central hub server and edge servers that are geographically proximate to regional groups of users, where the edge servers communicate directly with users and the hub server centrally coordinates activity among the edge servers and provides computational resources that are not feasible for the edge servers to maintain themselves.

A machine learning framework can be implemented among multiple computing devices in a distributed system. For example, edge computing can enable real-time and low-latency system feedback in cloud-based machine learning platforms. However, static machine learning models distributed at edge devices can become stale, and may therefore provide fast outputs but fail to effectively learn from local inputs. There is therefore a need in the art for distributed machine learning systems and methods that optimize learning at an edge device.

### SUMMARY

Embodiments of the present disclosure provide a distributed machine learning system that includes an edge device. In some cases, the edge device employs an edge machine learning model. According to some aspects, the edge device computes an objective function for the edge machine learning model based on a relationship between the edge machine learning model and a hub machine learning model received from a hub device, and updates the edge machine learning model based on the objective function. By updating the edge machine learning model based on the objective function, the edge device is thereby able to optimally incorporate knowledge and experience from the hub machine learning model into the edge machine learning model, which mitigates a potential drift in the edge machine learning model away from the hub machine learning model in response to learning from local data.

A method, apparatus, non-transitory computer readable medium, and system for distributed machine learning are described. One or more aspects of the method, apparatus, non-transitory computer readable medium, and system include obtaining a static machine learning model from a hub device; computing an objective function for a dynamic machine learning model based on a relationship between the dynamic machine learning model and the static machine learning model; and updating the dynamic machine learning model based on the objective function.

A method, apparatus, non-transitory computer readable medium, and system for distributed machine learning are described. One or more aspects of the method, apparatus, non-transitory computer readable medium, and system include obtaining user interaction data for a user; computing a policy function of a dynamic machine learning model based on the user interaction data, wherein the dynamic machine learning model is trained based on a relationship between the dynamic machine learning and a static machine learning model from a hub device; and recommending content to the user based on the policy function.

An apparatus, system, and method for distributed machine learning are described. One or more aspects of the apparatus, system, and method include an edge device including a memory and a processor, wherein the processor is configured to: obtain a static machine learning model from a hub device; compute an objective function for a dynamic machine learning model based on a relationship between the dynamic machine learning model and the static machine learning model; and update the dynamic machine learning model based on the objective function.

### BRIEF DESCRIPTION OF THE DRAWINGS

FIG. 1 shows an example of a distributed machine learning system according to aspects of the present disclosure.

FIG. 2 shows an example of an edge device according to aspects of the present disclosure.

FIG. 3 shows an example of a hub device according to aspects of the present disclosure.

FIG. 4 shows an example of a distributed machine learning system including multiple edge devices according to aspects of the present disclosure.

FIG. 5 shows an example of an architecture for training a dynamic machine learning model implemented as a reinforcement learning model according to aspects of the present disclosure.

FIG. 6 shows an example of an architecture for training a dynamic machine learning model implemented as a collaborative filtering model according to aspects of the present disclosure.

FIG. 7 shows an example of a method for edge-learned content recommendation according to aspects of the present disclosure.

FIG. 8 shows an example of a method for updating a dynamic machine learning model according to aspects of the present disclosure.

FIGS. 9, 10 and 11 show examples of a dashboard according to aspects of the present disclosure.

FIG. 12 shows an example of an algorithm for training a reinforcement learning model according to aspects of the present disclosure.

FIG. 13 shows an example of an algorithm for training a collaborative filtering model according to aspects of the present disclosure.

FIG. 14 shows an example of a method for recommending content to a user according to aspects of the present disclosure.

### DETAILED DESCRIPTION

Embodiments of the present disclosure relate generally to machine learning, and more specifically to distributed machine learning. Machine learning algorithms build a model based on sample data, known as training data, to make predictions or decisions without being explicitly programmed to do so. A distributed system is a system whose components are located on different networked computers, which communicate and coordinate their actions by passing messages to one another from any system. An example of a distributed system includes a hub server and edge servers that are geographically proximate to regional groups of users, where the hub server centrally coordinates activity among the edge servers and provides computational resources that are not feasible for the edge servers to maintain themselves.

A machine learning framework can be implemented among multiple computing devices in a distributed system. For example, edge computing can enable real-time and low-latency system feedback in cloud-based machine learning platforms. However, static machine learning models distributed at edge devices can become stale, and may therefore provide fast outputs but fail to effectively learn from local inputs.

For example, a machine learning algorithm trained on historical interactions of users can be used for recommending content to the users. Such an algorithm is often complex and benefits from training at a regular cadence. However, training the algorithm at a regular cadence can induce operational delay and therefore inhibit the algorithm from reacting quickly to real-time events and trends. Online learning on real-time data can mitigate the operational delay, but learning from a vast quantity of data that is provided at a high rate to a central hub is infeasible, and creates a bottleneck. The quantity of data can be reduced by sampling, but could result in a majority of the data being discarded, which would affect an ability of the central hub to properly recognize trends or events included in the data.

Instead, the algorithm can be distributed to edge devices within a distributed computing system that act as a first touchpoint for incoming user data. However, without continuously training the machine learning models at the edge devices, the machine learning models may provide predictions based on potentially outdated data. Furthermore, if the machine leaning models at the edge devices are trained independently from the machine learning model at the hub, the machine learning models can drift from each other and the hub machine learning model, which may result in varying standards of performance across the distributed computing system.

According to an aspect of the present disclosure, a distributed machine learning system includes an edge device. In some cases, the edge device is configured to obtain a static machine learning model from a hub device. In some cases, the edge device is further configured to compute an objective function for a dynamic machine learning model based on a relationship between the dynamic machine learning model and the static machine learning model. In some cases, the edge device is further configured to update the dynamic machine learning model based on the objective function.

By updating the edge machine learning model based on the objective function, the edge device is thereby able to optimally incorporate knowledge and experience from the hub machine learning model into the edge machine learning model, which mitigates a potential drift in the edge machine learning model away from the hub machine learning model in response to learning from local data. Furthermore, in some cases, updating the dynamic machine model based on the objective function can compensate for a relatively small amount of training data available at the edge device as compared to training data that would be available at the hub device.

As used herein, an “edge device” refers to a computing device (such as a server) that has a direct or a close (e.g., geographically proximate) connection to a user device. As used herein, a “hub device” refers to a computing device (such as a server) that has an indirect connection to the user device. For example, in some cases, a user device interacts with the edge device, and the edge device interacts with the hub device. In some cases, a hub device communicates with a set of edge devices, and each edge device can communicate with a set of user devices.

As used herein, a “static” machine learning model refers to a machine learning model that is frozen (e.g., not trained or updated) during a training process of the “dynamic” machine learning model. According to some aspects, the dynamic machine learning model is smaller than the static machine learning model (for example, by including fewer layers or layers including fewer dimensions), thereby making the dynamic machine learning model easier and more practical to implement on an edge device.

As used herein, an “objective function” refers to a function computed by a machine learning model that is optimized (e.g., maximized or minimized) during a training process of the machine learning model.

As used herein, a “policy function” refers to the function that takes a current state as input and outputs an action (or a probability distribution over a set of actions). In other words, in some cases, the policy function determines what decision an agent should make at any given time. Typically, an agent seeks to find the optimal policy function that maximizes some objective function over time. For example, in a product recommendation context, a policy function may be selected to maximize revenue from sales. A policy gradient refers to a gradient of the objective function with respect to a parameterization of the policy function. In other words, the policy function may be written in a form that depends on one or more parameters, and the policy gradient represents how the overall objective is impacted when the parameters are changed. In some cases, the policy function is implemented as a neural network, and the parameters correspond to node weights of the network.

As used herein, “user interaction data” refers to any data generated by an interaction between the user and the user device. For example, via a user device, a user may browse, search for, and view content, may add or remove content to or from a digital shopping cart, may purchase content, may return content, may rate or otherwise appraise the content, may provide a review of the content, etc. In some cases, the user interaction data relates to a user interaction with a content channel (e.g., a graphical user interface through which content is provided). In some cases, user interaction data can include a user rating matrix including a row corresponding to a user, a column corresponding to an item of content, and entries corresponding to the user's ratings for the items of content.

As used herein, “content” refers to any information that can be transmitted in graphical and/or auditory form, including but not limited to text, images, video, audio, websites, emails, etc. As used herein, a “content recommendation” refers to information that is intended to communicate to a user that the user may be interested in particular items of content.

An embodiment of the present disclosure is used in a content recommendation context. In an example, a user of a video streaming service generates user interaction data by browsing videos available from the service, watching videos on the service for different lengths of time, and providing preference feedback for videos the user has watched. A machine learning model at an edge device located in a same geographical region as the user receives the user interaction data and similar data from other users in the same region. The machine learning model (implemented as, for example, a reinforcement learning model) is trained based on the data to recommend a video for the user to watch on the streaming service. Therefore, the edge device avoids a latency and computational expense that would result from communicating the data to a hub device, processing the data at the hub device using a central machine learning model to obtain a recommendation, receiving the recommendation back at the edge device, and then communicating the recommendation to the user.

However, the training of the machine learning model is also constrained (in some cases, to a user-variable degree or by a hyperparameter) by a similar machine learning model imported from a hub, thereby “anchoring” the machine learning model at the edge to a learned baseline, which helps the edge device to prevent the machine learning model from unintentionally “drifting” outside of desired parameters. In some cases, the training process is continual, and the constraint can be adjusted throughout the training process.

Therefore, according to some aspects, computation on an edge device can help to provide low-latency experiences and can save on communication costs. Additionally, in some cases, the distributed machine learning system allows a third-party user, such as a content provider, to have finer control over how far the dynamic machine learning model can deviate from the static machine learning model. According to some aspects, the dynamic machine learning model automatically learns an amount of advice to be provided by the static machine learning model, thereby allowing the dynamic machine learning model to capture trends in real time or near real time.

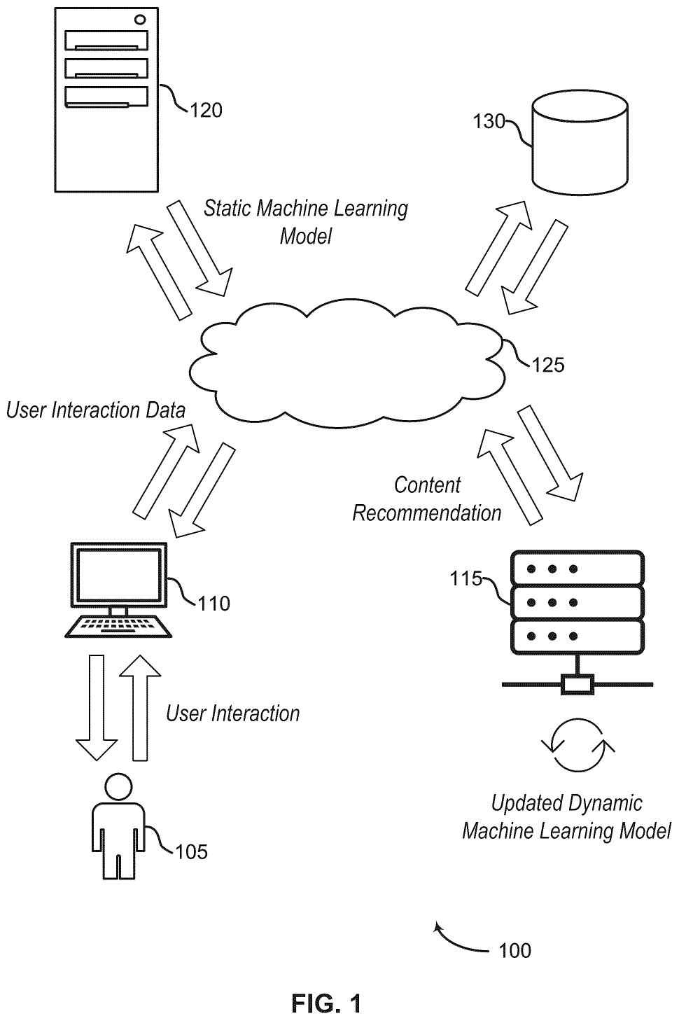

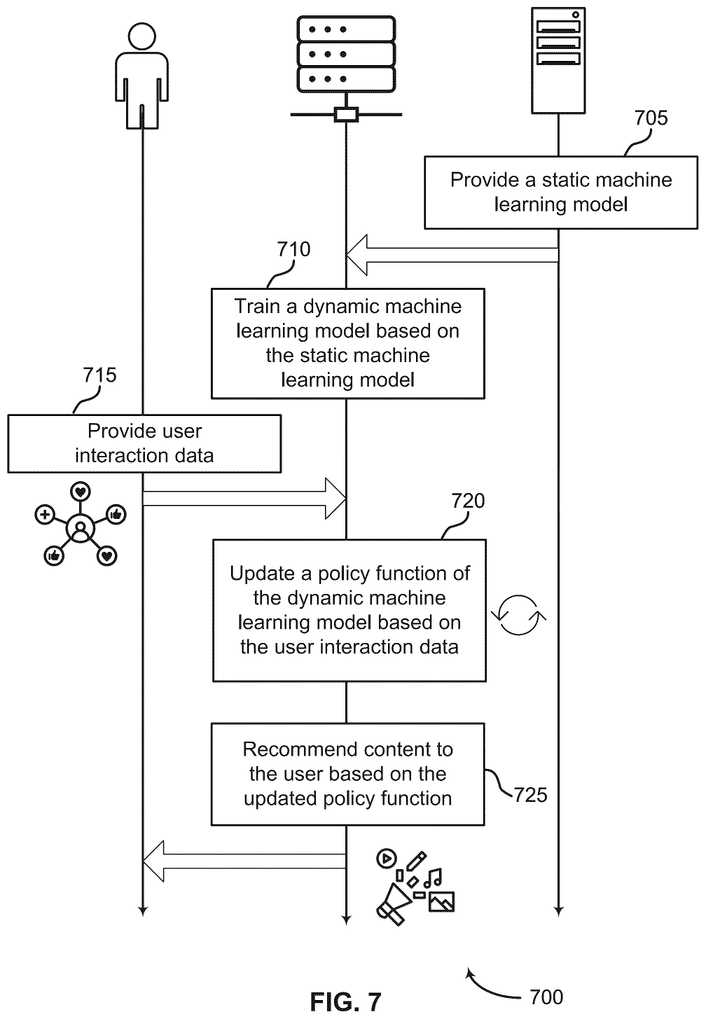

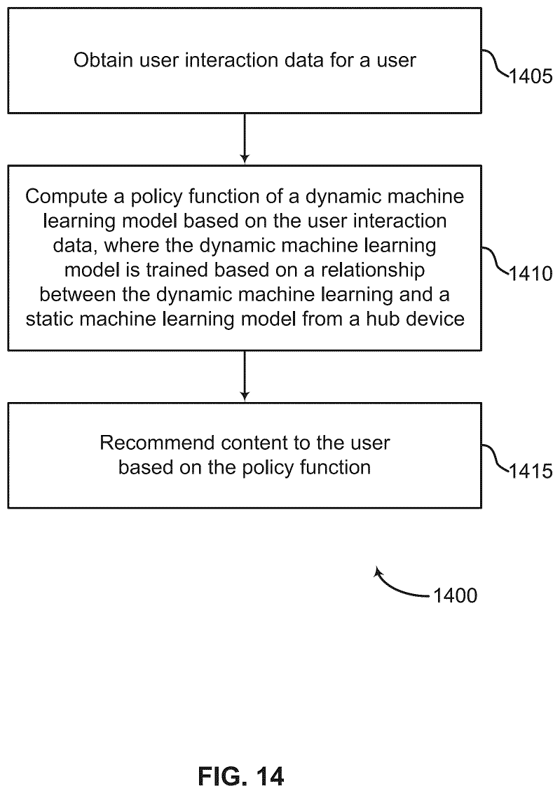

Example applications of the present disclosure in the content recommendation context are provided with reference to FIGS. 1, 4, 7, and 14. Details regarding the architecture of the distributed machine learning system are provided with reference to FIGS. 1-6. Details regarding a process for distributed machine learning are provided with reference to FIGS. 7-13. Details regarding a process for recommending content are provided with reference to FIG. 14.

### Distributed Machine Learning System

A system and apparatus for distributed machine learning is described with reference to FIGS. 1-6. One or more aspects of the system and apparatus include an edge device including a memory and a processor, wherein the processor is configured to: obtain a static machine learning model from a hub device; compute an objective function for a dynamic machine learning model based on a relationship between the dynamic machine learning model and the static machine learning model; and update the dynamic machine learning model based on the objective function.

Some examples of the system and apparatus further include the hub device, where the hub device is configured to train the static machine learning model. Some examples of the system and apparatus further include an additional edge device configured to train an additional dynamic machine learning model based on the static machine learning model.

In some aspects, the dynamic machine learning model comprises a reinforcement learning model. In some aspects, the dynamic machine learning model comprises a collaborative filtering model.

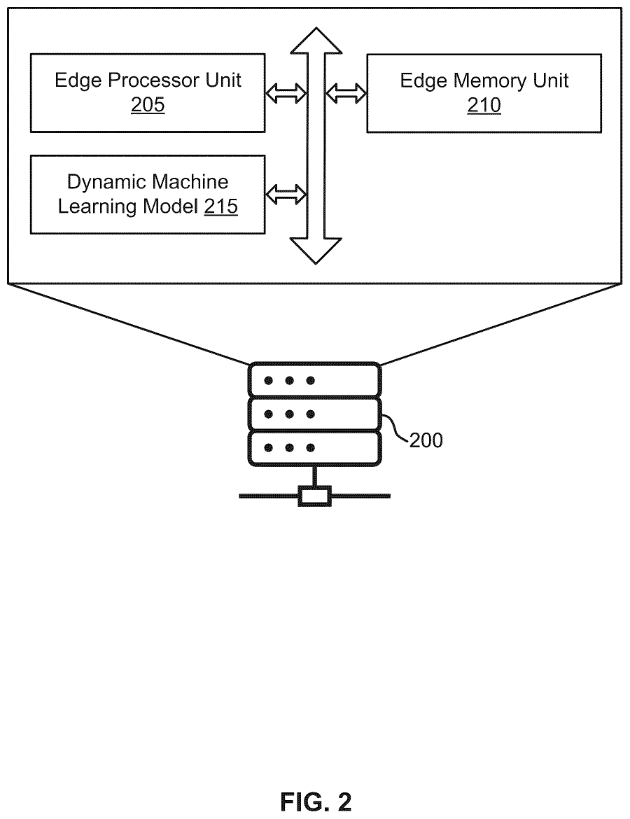

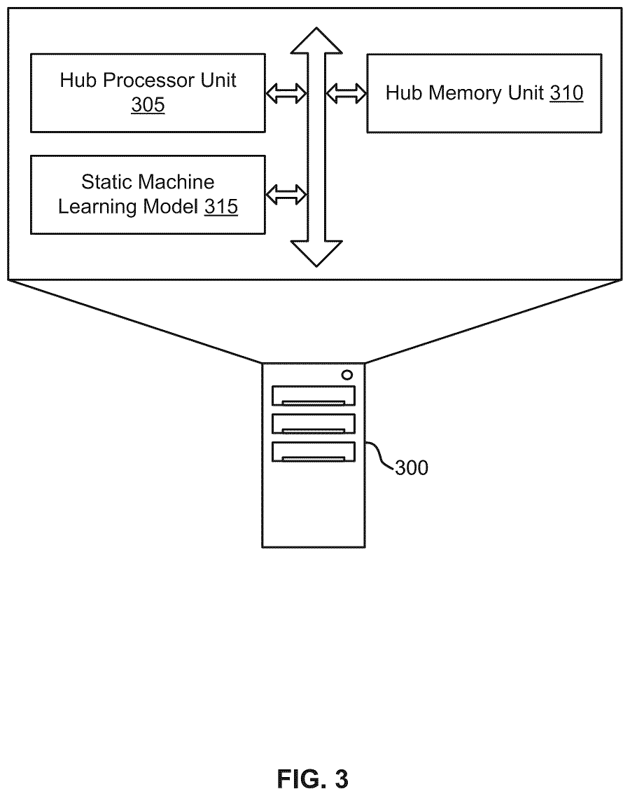

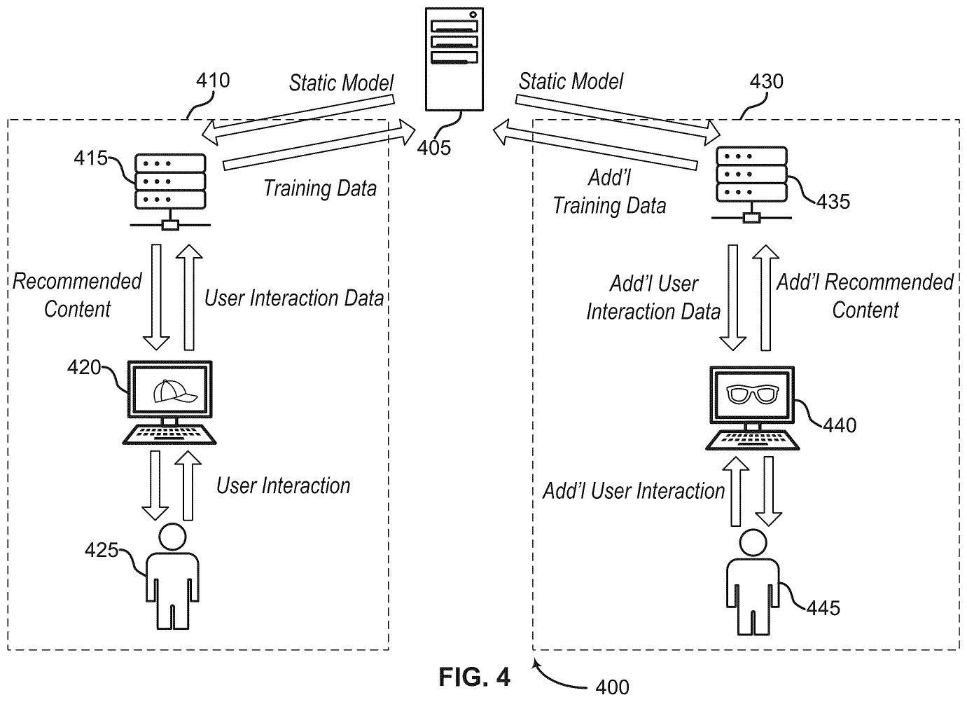

FIG. 1 shows an example of a distributed machine learning system 100 according to aspects of the present disclosure. The example shown includes user 105, user device 110, edge device 115, hub device 120, cloud 125, and database 130. Distributed machine learning system 100 is an example of, or includes aspects of, the corresponding element described with reference to FIG. 4. In some cases, user 105 is an example of the user described with reference to FIG. 4. User device 110 is an example of, or includes aspects of, the corresponding element described with reference to FIG. 4. Edge device 115 is an example of, or includes aspects of, the corresponding element described with reference to FIGS. 2 and 4. Hub device 120 is an example of, or includes aspects of, the corresponding element described with reference to FIGS. 3 and 4.

Referring to FIG. 1, in an example, edge device 115 receives a static machine learning model from hub device 120 and updates a dynamic machine learning model based on a relationship between the static machine learning model and the dynamic machine learning model. Meanwhile, user 105 interacts with user device 110 to generate user interaction data that is provided to edge device 115 via cloud 125. Edge device 115 receives the user interaction data and uses the updated dynamic machine learning model to generate a content recommendation for user 105 based on the user interaction data. Edge device 115 provides the content recommendation to user 105 via user device 110. In some cases, edge device 115 generates or retrieves the content based on the recommendation (for example, from database 130), and provides the recommended content to user 105 via user device 110.

According to some aspects, user device 110 is a personal computer, laptop computer, mainframe computer, palmtop computer, personal assistant, mobile device, or any other suitable processing apparatus. In some examples, user device 110 includes software that can receive and/or display content (i.e., information that can be transmitted in graphical and/or auditory form, including but not limited to text, images, video, audio, websites, emails, etc.) and/or a content recommendation (i.e., information that is intended to communicate to user 105 that user 105 may be interested in particular items of content).

According to some aspects, a user interface enables user 105 to interact with user device 110. In some embodiments, the user interface may include an audio device, such as an external speaker system, an external display device such as a display screen, or an input device (e.g., a remote-control device interfaced with the user interface directly or through an I/O controller module). In some cases, the user interface may be a graphical user interface. In some cases, the graphical user interface is provided by edge device 115.

According to some aspects, each of edge device 115 and hub device 120 include a computer implemented network. In some embodiments, the computer implemented network includes a machine learning model (such as the dynamic machine learning model described with reference to FIG. 2 and the static machine learning model described with reference to FIG. 3). Additionally, in some embodiments, each of edge device 115 and hub device 120 communicates with user device 110 and database 130 via cloud 125.

In some cases, each of edge device 115 and hub device 120 are respectively implemented on servers. A server provides one or more functions to users linked by way of one or more of various networks, such as cloud 125. In some cases, each of the servers include a single microprocessor board, which includes a microprocessor responsible for controlling all aspects of the server. In some cases, each of the servers use the microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, each of the servers are configured to send and receive hypertext markup language (HTML) formatted files (e.g., for displaying web pages). In various embodiments, each of the servers comprise a general-purpose computing device, a personal computer, a laptop computer, a mainframe computer, a supercomputer, or any other suitable processing apparatus.

Further detail regarding the architecture of edge device 115 is provided with reference to FIGS. 2 and 4-6. Further detail regarding the architecture of hub device 120 is provided with reference to FIGS. 3 and 4. Further detail regarding a process for distributed machine learning is provided with reference to FIGS. 7-13. Further detail regarding a process for content recommendation is provided with reference to FIG. 14.

Cloud 125 is a computer network configured to provide on-demand availability of computer system resources, such as data storage and computing power. In some examples, cloud 125 provides resources without active management by a user. The term “cloud” is sometimes used to describe data centers available to many users over the Internet. Some large cloud networks have functions distributed over multiple locations from central servers. A server is designated an edge server if the server has a direct or close connection to a user. For example, in some cases, edge device 115 is designated an edge server. In some cases, cloud 125 is limited to a single organization. In other examples, cloud 125 is available to many organizations. In one example, cloud 125 includes a multi-layer communications network comprising multiple edge routers and core routers. In another example, cloud 125 is based on a local collection of switches in a single physical location. According to some aspects, cloud 125 provides communications between user device 110, edge device 115, hub device 120, and database 130.

Database 130 is an organized collection of data. In an example, database 130 stores data in a specified format known as a schema. According to some aspects, database 130 is structured as a single database, a distributed database, multiple distributed databases, or an emergency backup database. In some cases, a database controller manages data storage and processing in database 130. In some cases, a user interacts with the database controller. In other cases, the database controller operates automatically without interaction from a user. According to some aspects, database 130 is external to edge device 115 and hub device 120 and communicates with edge device 115 and hub device 120 via cloud 125. According to some aspects, database 130 is included in edge device 115. According to some aspects, database 130 is included in hub device 120. According to some aspects, each of edge device 115 and hub device 120 are geographically proximate to a database. According to some aspects, each of edge device 115 and hub device 120 include a database.

FIG. 2 shows an example of an edge device 200 according to aspects of the present disclosure. Edge device 200 is an example of, or includes aspects of, the corresponding element described with reference to FIGS. 1 and 4. In one aspect, edge device 200 includes edge processor unit 205, edge memory unit 210, and dynamic machine learning model 215.

Edge processor unit 205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, edge processor unit 205 is configured to operate a memory array using a memory controller. In other cases, a memory controller is integrated into edge processor unit 205. In some cases, edge processor unit 205 is configured to execute computer-readable instructions stored in edge memory unit 210 to perform various functions. In some aspects, edge processor unit 205 includes special-purpose components for modem processing, baseband processing, digital signal processing, or transmission processing.

Edge memory unit 210 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor of edge processor unit 205 to perform various functions described herein. In some cases, edge memory unit 210 includes a basic input/output system (BIOS) that controls basic hardware or software operations, such as an interaction with peripheral components or devices. In some cases, edge memory unit 210 includes a memory controller that operates memory cells of edge memory unit 210. For example, the memory controller may include a row decoder, column decoder, or both. In some cases, memory cells within edge memory unit 210 store information in the form of a logical state.

According to some aspects, edge device 200 obtains a static machine learning model from a hub device. According to some aspects, edge device 200 obtains user interaction data for a user. According to some aspects, edge device 200 computes an objective function for a dynamic machine learning model based on a relationship between dynamic machine learning model 215 and the static machine learning model. In some examples, edge device 200 updates dynamic machine learning model 215 based on the objective function.

According to some aspects, dynamic machine learning model 215 includes one or more artificial neural networks (ANNs). An ANN is a hardware or a software component that includes a number of connected nodes (i.e., artificial neurons) that loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of the inputs. In some examples, nodes may determine corresponding output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the neural network. Hidden representations are machine-readable data representations of an input that are learned from a neural network's hidden layers and are produced by the output layer. As the neural network's understanding of the input improves as the network is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

In some aspects, the static machine learning model and dynamic machine learning model 215 include reinforcement learning models. Reinforcement learning is one of three basic machine learning paradigms, alongside supervised learning and unsupervised learning. Specifically, reinforcement learning relates to how software agents make decisions to maximize a reward. The decision-making model may be referred to as a policy. This type of learning differs from supervised learning in that labeled training data is not needed, and errors need not be explicitly corrected. Instead, reinforcement learning balances exploration of unknown options and exploitation of existing knowledge.

According to some aspects, the static machine learning model and dynamic machine learning model 215 are implemented within an actor-critic framework. For example, in some cases, the static machine learning model includes a static actor ANN and dynamic machine learning model 215 includes a dynamic actor ANN and a critic ANN. In some cases, an actor ANN approximates an agent's policy (e.g., a probability distribution that provides a probability of selecting a continuous action given some state of an environment). In some cases, the critic ANN approximates a value function (e.g., the agent's estimate of future rewards that follow the current state). In some cases, the dynamic actor ANN is based on the static actor ANN, and the dynamic actor ANN and the critic ANN interact to shift the policy towards a more optimal state.

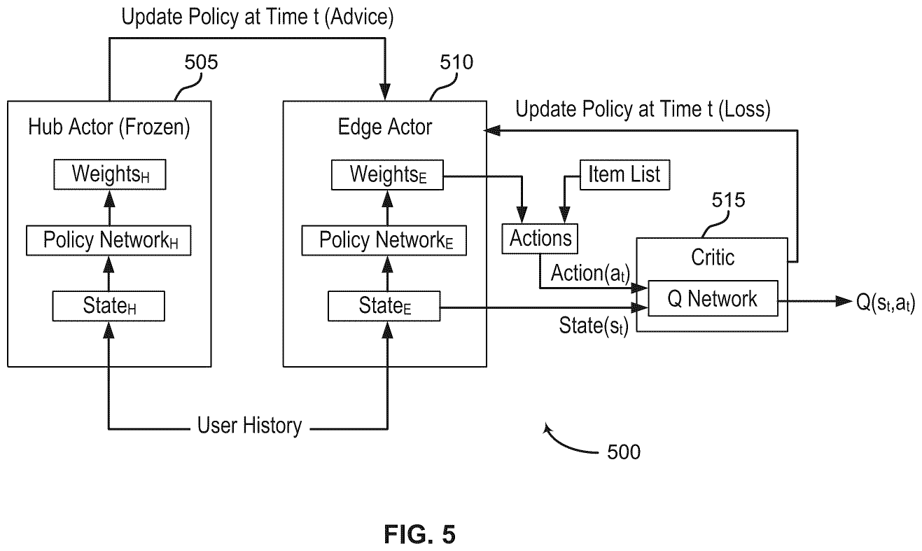

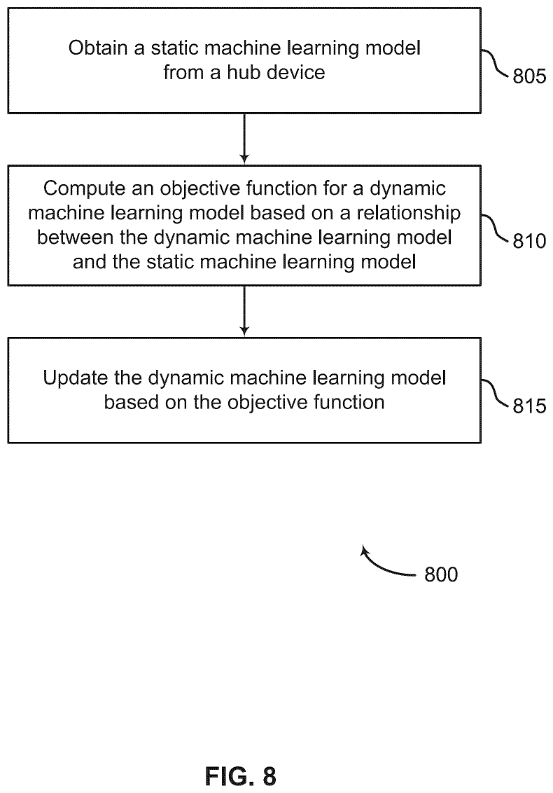

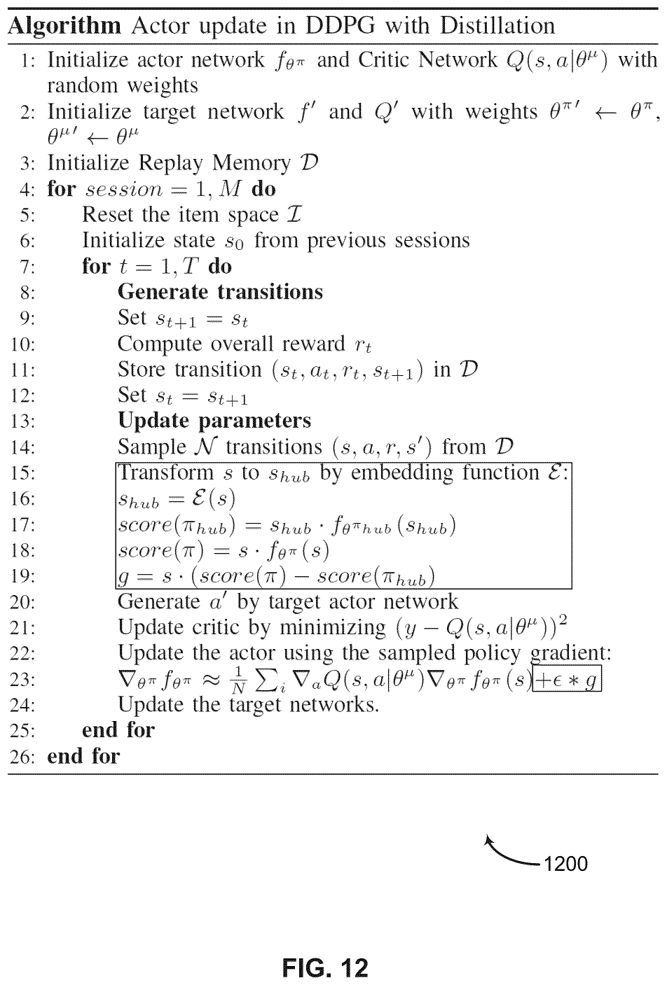

An example implementation of an architecture for training a reinforcement learning framework according to aspects of the present disclosure is described with reference to FIG. 5. Examples of training a reinforcement learning model according to aspects of the present disclosure are provided with reference to FIGS. 8 and 12.

In some aspects, the static machine learning model and dynamic machine learning model 215 include collaborative filtering models. According to some aspects, collaborative filtering models use ANNs to filter information or patterns using techniques involving collaboration among multiple agents, viewpoints, data sources, etc. In a content recommendation context, collaborative filtering techniques are used to make predictions (the “filtering” aspect of “collaborative filtering”) about the interests of a user by collecting preferences or taste information from many users (the “collaborative” aspect of “collaborative filtering”).

For example, in some cases, an underlying assumption of a collaborative filtering approach is that if a first user has a same opinion as a second user with regards to a first item of content (as indicated by user interaction data for the first and second users), the first user is more likely to share the second user's opinion with regards to a second item of content than that of a randomly chosen third user. Therefore, according to some aspects, dynamic machine learning model 215 implements a collaborative filtering model for making a prediction about which content a user should like given user interaction data for the user (which may include, for example, a list of the user's likes and dislikes) and user interaction data for one or more other users, which differs from a simpler approach of determining an average (e.g., non-specific) score for each item of content (for example, based on a number of votes for the item of content).

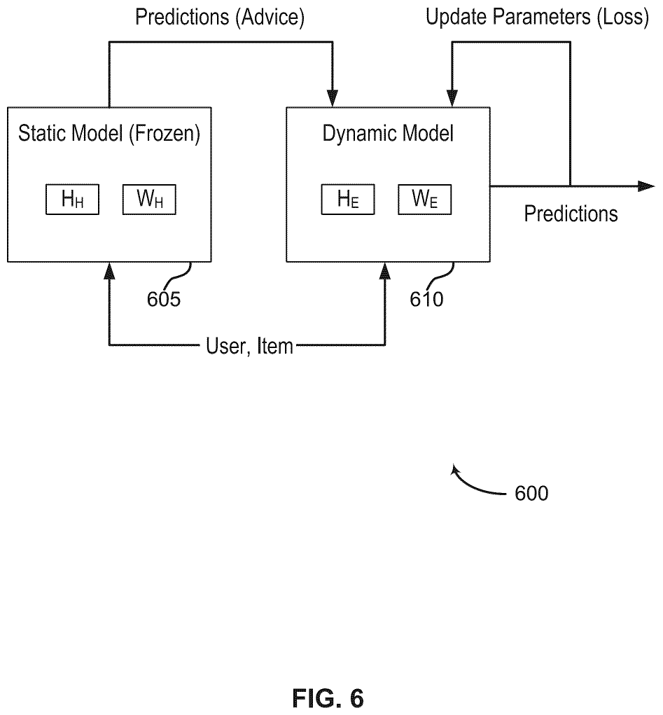

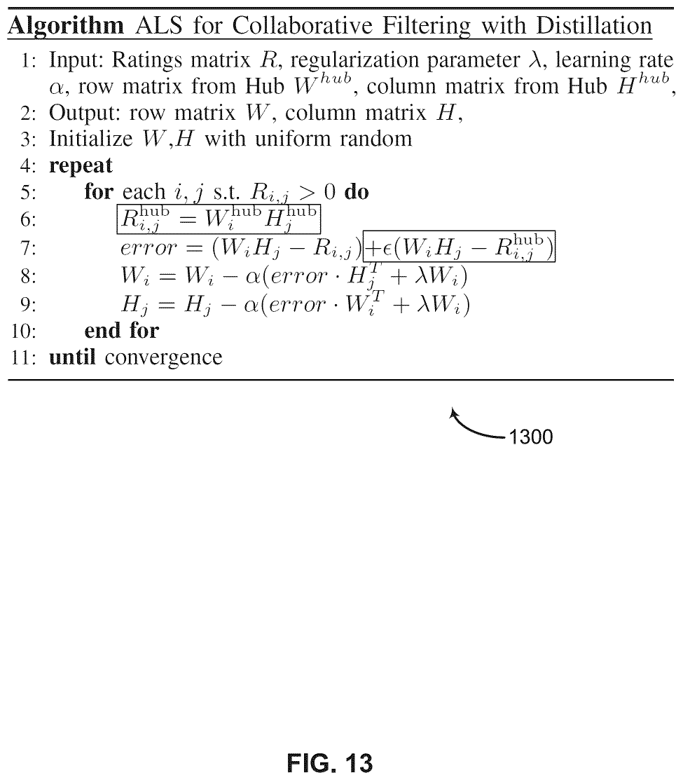

An example implementation of an architecture for training a collaborative filtering framework according to aspects of the present disclosure is described with reference to FIG. 6. Examples of training a collaborative filtering model according to aspects of the present disclosure are provided with reference to FIGS. 8 and 13.

In some examples, edge device 200 computes a distance function between dynamic machine learning model 215 and the static machine learning model, where the objective function is based on the distance function. In some examples, edge device 200 scales the distance function by on a scaling parameter to obtain a penalty term, where the objective function includes the penalty term.

In some examples, edge device 200 identifies a static policy function for the static machine learning model. In some examples, edge device 200 identifies a dynamic policy function for dynamic machine learning model 215, where the distance function is computed between the dynamic policy function and the static policy function.

In some examples, edge device 200 initializes dynamic machine learning model 215 based on the static machine learning model. In some examples, edge device 200 collects training data at the edge device 200, where edge device 200 is updated based on the training data. In some examples, edge device 200 transmits the training data from edge device 200 to the hub device.

In some examples, edge device 200 computes a policy function of dynamic machine learning model 215 based on the user interaction data, where dynamic machine learning model 215 is trained based on a relationship between dynamic machine learning model 215 and the static machine learning model from the hub device.

In some examples, edge device 200 identifies a state based on the user interaction data, where the policy function takes the state as input. In some aspects, the policy function includes a neural network trained using reinforcement learning. In some aspects, the policy function includes a user matrix and an item matrix trained using collaborative filtering.

In some examples, edge device 200 recommends content to a user based on dynamic machine learning model 215, where the training data includes user interaction data with the content. In some examples, edge device 200 recommends content to the user based on the policy function. In some examples, dynamic machine learning model 215 recommends content to the user based on the policy function.

According to some aspects, dynamic machine learning model 215 is implemented as software stored in edge memory unit 210 and executable by edge processor unit 205, as firmware, as one or more hardware circuits, or as a combination thereof.

According to some aspects, an additional edge device similar to edge device 200 is provided. According to some aspects, the additional edge device collects additional training data. In some examples, the additional edge device transmits the additional training data from the additional edge device to the hub device, where the static machine learning model is trained based on the additional training data. According to some aspects, the additional edge device is configured to train an additional dynamic machine learning model based on the static machine learning model.

FIG. 3 shows an example of a hub device 300 according to aspects of the present disclosure. Hub device 300 is an example of, or includes aspects of, the corresponding element described with reference to FIGS. 1 and 4. In one aspect, hub device 300 includes hub processor unit 305, hub memory unit 310, and static machine learning model 315.

Hub processor unit 305 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, hub processor unit 305 is configured to operate a memory array using a memory controller. In other cases, a memory controller is integrated into hub processor unit 305. In some cases, hub processor unit 305 is configured to execute computer-readable instructions stored in hub memory unit 310 to perform various functions. In some aspects, hub processor unit 305 includes special-purpose components for modem processing, baseband processing, digital signal processing, or transmission processing.

Hub memory unit 310 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor of hub processor unit 305 to perform various functions described herein. In some cases, hub memory unit 310 includes a basic input/output system (BIOS) that controls basic hardware or software operations, such as an interaction with peripheral components or devices. In some cases, hub memory unit 310 includes a memory controller that operates memory cells of hub memory unit 310. For example, the memory controller may include a row decoder, column decoder, or both. In some cases, memory cells within hub memory unit 310 store information in the form of a logical state.

According to some aspects, hub device 300 is configured to provide static machine learning model 315 to an edge device (such as the edge device described with reference to FIGS. 1-2 and 4). According to some aspects, hub device 300 is configured to train static machine learning model 315. According to some aspects, hub device 300 trains static machine learning model 315 based on the training data from the edge device.

According to some aspects, static machine learning model 315 includes one or more ANNs. According to some aspects, static machine learning model 315 includes a reinforcement learning model. According to some aspects, static machine learning model 315 includes a collaborative filtering model. According to some aspects, static machine learning model 315 is implemented as software stored in hub memory unit 310 and executable by hub processor unit 305, as firmware, as one or more hardware circuits, or as a combination thereof.

Static machine learning model 315 is an example of, or includes aspects of, the corresponding element described with reference to FIGS. 5 and 6. According to some aspects, static machine learning model is implemented as software stored in hub memory unit 310 and executable by hub processor unit 305, as firmware, as one or more hardware circuits, or as a combination thereof.

FIG. 4 shows an example of a distributed machine learning system 400 including multiple edge devices according to aspects of the present disclosure. The example shown includes hub device 405, first region 410, edge device 415, user device 420, user 425, second region 430, additional edge device 435, additional user device 440, and additional user 445.

Distributed machine learning system 400 is an example of, or includes aspects of, the corresponding element described with reference to FIG. 1. Hub device 405 is an example of, or includes aspects of, the corresponding element described with reference to FIGS. 1 and 3. Edge device 415 is an example of, or includes aspects of, the corresponding element described with reference to FIGS. 1 and 2. User device 420 is an example of, or includes aspects of, the corresponding element described with reference to FIG. 1. User 425 is an example of the user described with reference to FIG. 1.

Referring to FIG. 4, edge device 415 is located in first region 410 and additional edge device 435 (a similar device to edge device 415) is located in second region 430. Each of edge device 415 and additional edge device 435 are connected to hub device 405 (for example, through a cloud network as described with reference to FIG. 1). Each of edge device 415 and additional edge device 435 respectively include a dynamic machine learning model for recommending content to user 425 and additional user 445, where the dynamic machine learning models are respectively trained based on user interaction data from user device 420 and additional user device 440 according to local dynamic policies in a manner that can be close to a static policy from hub device 405.

This separation of learning among the dynamic machine learning models allows distributed machine learning system 400 to provide a fast response time, scalability to computational power of edge device 415 and additional edge device 435, and robustness of recommendations from edge device 415 and additional edge device 435 recommendations to respectively connected user device 420 and additional user device 440.

For example, if hats are trending as a search topic in first region 410 and user interaction data relating to hats are sent to hub device 405, the regional priority of hats in content recommendation in first region 410 may be lost if only a global model is learned at hub device 405. Likewise, if eyeglasses are trending as a search topic in second region 430 and additional user interaction data relating to eyeglasses are sent to hub device 405, the regional priority of eyeglasses in content recommendation in second region 430 may be lost if only a global model is learned at hub device 405. Furthermore, if local models are sent to be learned at hub device 405, performance latency can increase due to a number of data hops within the system.

Instead, in some cases, each of edge device 415 and additional edge device 435 maintains a corresponding version of a policy that is adjustably close to the policy of hub device 405, thereby making and/or providing appropriately relevant content recommendations in first region 410 and second region 430. Furthermore, in some cases, each of edge device 415 and additional edge device 435 provide gather training data based on user interaction data and provide the training data to hub device 405, thereby allowing a machine learning model of hub device 405 to be trained.

FIG. 5 shows an example of an architecture 500 for training a dynamic machine learning model implemented as a reinforcement learning model according to aspects of the present disclosure. The example shown includes hub actor 505, edge actor 510, and critic 515.

Referring to FIG. 5, in some cases, a static machine learning model as described with reference to FIGS. 1 and 3-4 is implemented as hub actor 505. Hub actor 505 is provided to an edge device as described with reference to FIGS. 1-2 and 4. Edge actor 510 and critic 515 are implemented as a dynamic machine learning model for the edge device as described with reference to FIGS. 1-2 and 4. In some cases, each of hub actor 505 and edge actor 510 comprise an N-dimensional embedding layer of user interaction data (e.g., a user history) fed into a recurrent neural network (RNN) including gated recurrent unit (GRU) cells to produce K sets of weights used to score content.

An RNN is a class of ANN in which connections between nodes form a directed graph along an ordered (i.e., a temporal) sequence. This enables an RNN to model temporally dynamic behavior such as predicting what element should come next in a sequence. Thus, an RNN is suitable for tasks that involve ordered sequences such as text recognition (where words are ordered in a sentence). The term RNN may include finite impulse recurrent networks (characterized by nodes forming a directed acyclic graph), and infinite impulse recurrent networks (characterized by nodes forming a directed cyclic graph).

In some cases, critic 515 is comprises an N-dimensional input layer with K items of content that is fed into the RNN, and a dense layer to generate Q values.

In some cases, the dynamic machine learning model is configured to use reinforcement learning to predict recommended content for a user based on user interaction data. In some cases, architecture 500 is configured to update the dynamic machine learning model according to a deep deterministic policy gradient algorithm as described with reference to FIGS. 8 and 12. In some cases, hub actor 505 is frozen (e.g., not updated) at the edge device while edge actor 510 is updated.

FIG. 6 shows an example of an architecture 600 for training a dynamic machine learning model implemented as a collaborative filtering model according to aspects of the present disclosure. In one aspect, architecture 600 includes static machine learning model 605 and dynamic machine learning model 610.

Referring to FIG. 6, according to some aspects, dynamic machine learning model 610 and static machine learning model 605 are implemented as collaborative filtering models for generating a content recommendation. In some cases, dynamic machine learning model 610 is updated based on static machine learning model 605 according to an alternating least squares algorithm as described with reference to FIGS. 8 and 13. For example, in some cases, user interaction data including a user rating matrix relating to the user and an item of content is provided to static machine learning model 605 and dynamic machine learning model 610. Static machine learning model 605 provides “advice” to dynamic machine learning model 610 during the training process via the objective functions described with reference to FIGS. 8 and 13. Dynamic machine learning model 610 learns to generate content recommendation predictions by filtering a user rating matrix into user matrix H and content matrix W, and the edge device optimizes the objective functions based on the predictions.

### Edge Learning

A method for distributed machine learning is described with reference to FIGS. 7-13. One or more aspects of the method include obtaining a static machine learning model from a hub device; computing an objective function for a dynamic machine learning model based on a relationship between the dynamic machine learning model and the static machine learning model; and updating the dynamic machine learning model based on the objective function.

Some examples of the method further include computing a distance function between the dynamic machine learning model and the static machine learning model, wherein the objective function is based on the distance function. Some examples of the method further include scaling the distance function by on a scaling parameter to obtain a penalty term, wherein the objective function includes the penalty term.

Some examples of the method further include identifying a static policy function for the static machine learning model. Some examples further include identifying a dynamic policy function for the dynamic machine learning model, wherein the distance function is computed between the dynamic policy function and the static policy function.

Some examples of the method further include initializing the dynamic machine learning model based on the static machine learning model. Some examples of the method further include collecting training data at the edge device, wherein the edge device is updated based on the training data.

Some examples of the method further include recommending content to a user based on the dynamic machine learning model, wherein the training data comprises user interaction data with the content. Some examples of the method further include transmitting the training data from the edge device to the hub device. Some examples further include training the static machine learning model based on the training data from the edge device.

Some examples of the method further include collecting additional training data at an additional edge device. Some examples further include transmitting the additional training data from the additional edge device to the hub device, wherein the static machine learning model is trained based on the additional training data.

In some aspects, the static machine learning model and the dynamic machine learning model comprise reinforcement learning models. In some aspects, the static machine learning model and the dynamic machine learning model comprise collaborative filtering models.

FIG. 7 shows an example of a method 700 for edge-learned content recommendation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 7, according to some aspects, a distributed machine learning system includes a dynamic machine learning model that can be deployed at an edge device which, in tandem with a static machine learning model from a hub device, can deliver in-the-moment personalization for users. In some cases, the dynamic machine learning model is fast-learning and lightweight. In some cases, the dynamic machine learning model learns at the edge device with “advice” from the hub device via the static machine learning model.

For example, in some cases, after the dynamic machine learning model is initialized either through pruning the static machine learning model or by learning a lighter model offline at the hub device from data available at the hub device, the static machine learning model is frozen while the dynamic machine learning model is trained. During the training process, the dynamic machine learning model can learn to mimic the static model to a variable amount (via a scaling parameter selected either as a hyperparameter of the dynamic machine learning model or by a third-party user, such as a content provider) based on a divergence of a dynamic policy function for the dynamic machine learning model from a static policy function for the static machine learning model. Accordingly, a minimum desired accuracy at the edge device can be maintained, while an increase in data security and speed and a cost advantage over a centralized machine learning system are realized.

Furthermore, in some cases, the updated dynamic machine learning model updates a policy function based on user interaction data received from the user (for example, content views, content appraisals, content purchases, etc. provided by the user to a user device) and recommends content to the user based on the updated policy function.

At operation 705, the system provides a static machine learning model. In some cases, the operations of this step refer to, or may be performed by, a hub device as described with reference to FIGS. 1, 3, and 4. For example, in some cases, the hub device prunes the static machine learning model from a bigger machine learning model implemented at the hub device, or trains the static machine learning model as a lightweight model at the hub device.

At operation 710, the system trains a dynamic machine learning model based on the static machine learning model. In some cases, the operations of this step refer to, or may be performed by, an edge device as described with reference to FIGS. 1, 2, and 4. In some cases, the edge device bootstraps the dynamic machine learning model from the static machine learning model. In some cases, the edge device trains the dynamic machine learning model as described with reference to FIG. 8.

At operation 715, a user provides user interaction data. In some cases, the operations of this step refer to, or may be performed by, a user as described with reference to FIGS. 1 and 4. For example, in some cases, a user interacts with a user device, and data generated by the user interaction is transmitted to the edge device as user interaction data. In an example, a user browses an e-commerce website on the user device, makes a purchase from the website, and leaves a review on the website. The edge device can receive data relating to the browsing, the purchase, and the review as user interaction data. In some cases, the user interaction data can describe a relationship between the user and content. For example, where the user browses the e-commerce website, the browsing, the purchase, and the review relate to one or more items of content, and this relationship is included in the user interaction data.

At operation 720, the system updates a policy function of the dynamic machine learning model based on the user interaction data. In some cases, the operations of this step refer to, or may be performed by, an edge device as described with reference to FIGS. 1, 2, and 4. For example, in some cases, the edge device updates the policy function as described with reference to FIGS. 8 and 14.

At operation 725, the system recommends content to the user based on the updated policy function. In some cases, the operations of this step refer to, or may be performed by, an edge device as described with reference to FIGS. 1, 2, and 4. For example, in some cases, the dynamic machine learning model outputs a prediction of content that should be provided to the user. In some cases, for example, the edge device recommends the content to the user by providing a message to the user that corresponds to the prediction. In some cases, the edge device generates the message based on the prediction. In some cases, the edge device retrieves the message from a database (such as a database as described with reference to FIG. 1) according to a database schema relating the user and the content. In some cases, the edge device provides the recommended content to the user in response to the prediction. In some cases, the edge device generates the recommended content. In some cases, the edge device retrieves the recommended content from a database (such as a database as described with reference to FIG. 1) according to a database schema relating the user and the recommended content.

FIG. 8 shows an example of a method 800 for updating a dynamic machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 8, an edge device updates a dynamic machine learning model at the edge device based on a static machine learning model received from a hub device. In some cases, the edge device and the hub device are included in a distributed machine learning system. In some cases, the edge device updates the machine learning model based on an objective function relating to policy functions respectively corresponding to the dynamic machine learning model and the static machine learning model. In some cases, the edge device computes the objective function such that the objective function is influenced by the static policy. In some cases, the influence is expressed as a divergence of the dynamic machine learning model from the static machine learning model. In some cases, an amount of the influence can be adjusted according to a scaling parameter. Accordingly, some aspects of the present disclosure provide an edge device that can update a dynamic machine learning model at the edge device based on a static machine learning model from a hub device, which allows the dynamic machine learning model to effectively incorporate knowledge gained at the hub device while operating with a speed and efficiency that follows from training at the edge device.

At operation 805, the system obtains a static machine learning model from a hub device. In some cases, the operations of this step refer to, or may be performed by, an edge device as described with reference to FIGS. 1, 2, and 4. In some cases, the static machine learning model is pruned from a larger static machine learning model stored at the hub device. In some cases, the static machine learning model is trained based on training data collected from the edge device. In some examples, the edge device initializes a dynamic machine learning model based on the static machine learning model. In some aspects, the static machine learning model and the dynamic machine learning model include reinforcement learning models. In some aspects, the static machine learning model and the dynamic machine learning model include collaborative filtering models.

At operation 810, the system computes an objective function for a dynamic machine learning model based on a relationship between the dynamic machine learning model and the static machine learning model. In some cases, the operations of this step refer to, or may be performed by, an edge device as described with reference to FIGS. 1, 2, and 4.

For example, in some cases, the edge device computes the objective function, where the objective function is given by Equation 1:

$$f ( π ) + ϵ \cdot D ( g ( π ) , g ( {π}_{h u b} ) ) \qquad ( 1 )$$

Referring to Equation 1, π is a dynamic policy for the dynamic machine learning model and ƒ(π) is a base objective function on the dynamic policy w. In some cases, the dynamic policy w is stochastic. In some cases, the dynamic policy if is deterministic.

In some cases, D(g(π),g(π_{hub})) is a distance function between the dynamic machine learning model and the static machine learning model and π_{hub} is a static policy for the static machine learning model, where g(π) is a dynamic policy function for the dynamic machine learning model that captures some characteristics of π and g(π_{hub}) is a static policy function for the static machine learning model that captures some characteristics of π_{hub}. In some cases, the distance function D(g(π),g(π_{hub})) is a measure of similarity, such as a Euclidean norm, between the dynamic policy function g(π) and the static policy function π_{hub}.

In some cases, ∈ is a scaling parameter. In some cases, ∈·D(g(π), g(π_{hub})) is a penalty term. In some cases, ∈ has a value equal to a number included in the range of zero to infinity. In some cases, a value of the scaling parameter E can be adjusted by a third-party user (such as a content provider). In some cases, a value of the scaling parameter ∈ is set as a hyperparameter. In some cases, the dynamic machine learning model is configured to learn an optimal value of the scaling parameter ∈.

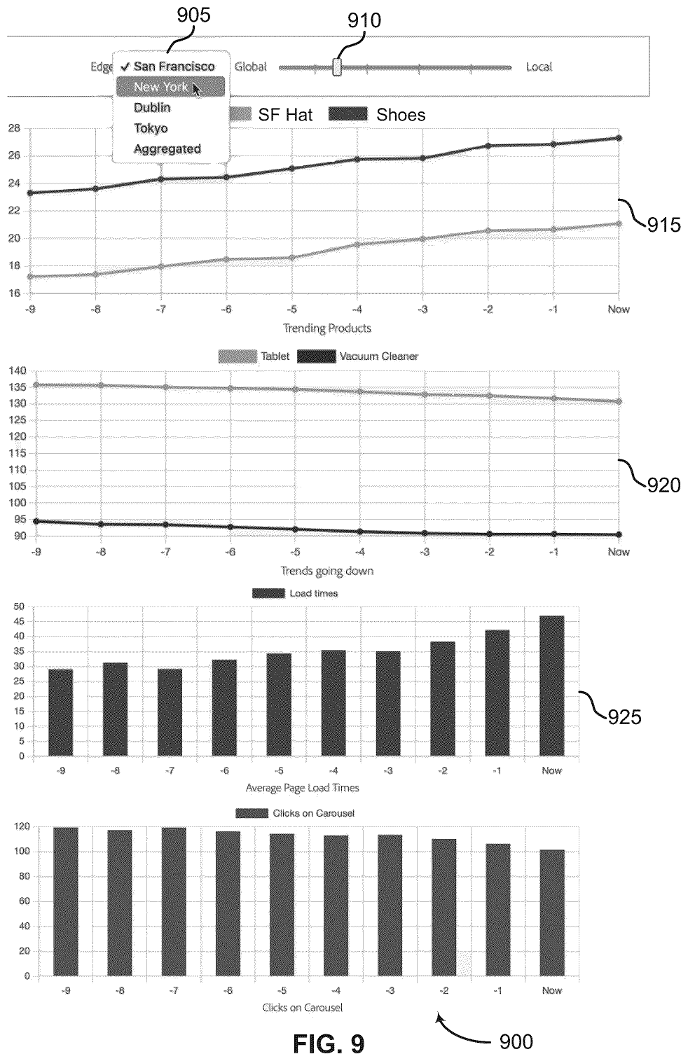

In some cases, by adjusting the scaling parameter ∈, a divergence of the dynamic machine learning model from the static machine learning model is controlled. For example, when ∈=0, the objective function is equal to the base objective function ƒ(π). In some cases, as E increases, an influence of the distance function on the objective function increases, thereby increasing an influence of the static policy function on the objective function. Examples of a dashboard including a slider corresponding to a value of the scaling parameter are described with reference to FIGS. 9-11.

At operation 815, the system updates the dynamic machine learning model based on the objective function. In some cases, the operations of this step refer to, or may be performed by, an edge device as described with reference to FIGS. 1, 2, and 4. For example, in some cases, the edge device updates the dynamic machine learning model by updating parameters of the dynamic machine learning model such that the objective function is minimized or maximized. In some examples, the edge device collects training data at the edge device. In some cases, the edge device is updated based on the training data. In some cases, the training data includes user interaction data.

In some cases, the dynamic machine learning model and the static machine learning model include reinforcement learning models. In some cases, an actor and a critic of the reinforcement learning model are included at the edge device, and a frozen critic is received at the edge device from the hub device. In an example, a dynamic policy π is a dynamic recommendation policy, static policy π_{hub} is a static recommendation policy, and the edge device determines the objective function according to Equation 2:

$$- {\sum }_{s , a} {d}^{π} ( s ) \cdot π ( a \vert s ) \cdot r ( s , a ) + ϵ \cdot KL ( π , {π}_{h u b} ) \qquad ( 2 )$$

Referring to Equation 2, d^{π}(s) is a stationary distribution of a state s following the dynamic recommendation policy π, r(s, a) is a reward of being in state s and executing action a, and KL(π, π_{hub}) is a Kullback-Leibler divergence between the dynamic recommendation policy π and the static recommendation policy π_{hub}. Comparing Equations 1 and 2, −Σ_{s,a} d^{π}(s)·r(a|s)·r(s, a) of Equation 2 corresponds to the base objective function ƒ(π) of Equation 1, and ∈·KL(π, π_{hub}) of Equation 2 is a penalty term that corresponds to the penalty term ∈·D(g(π), g(π_{hub})) of Equation 1. In some cases, the edge device updates the dynamic machine learning model by minimizing the objective function according to Equation 2.

In some cases, the dynamic machine learning model is implemented as a reinforcement learning model, the edge device is implemented as a content recommendation system, the dynamic recommendation policy w and the static recommendation policy π_{hub} are fed into scoring functions, such as page ranking functions, and the edge device determines the objective function according to Equation 3:

$$- {\sum }_{s , a} {d}^{π} ( s ) \cdot π ( a \vert s ) \cdot r ( s , a ) + ϵ \cdot ‖ score ( π ) - score ( {π}_{h u b} ) ‖ \qquad ( 3 )$$

Referring to Equation 3, the penalty term ∈·∥score(π)−score(π_{hub})∥ provides implicit advice from the frozen hub actor to the edge actor. In some cases, the scoring function ∥score(π)−score(π_{hub})∥ is a ranking function on a set of states, such as all content available for recommendation. In some cases, the objective function according to Equation 3 is applied in an actor update using a deep deterministic policy gradient (DDPG) with distillation context, as described with reference to FIG. 12.

In some cases, the dynamic machine learning model and the static machine learning model include collaborative filtering models. In an example, the edge device computes a penalized deep factorization objective according to Equation 4:

$$‖ HW - R ‖ + ϵ \cdot ‖ HW - {R}_{h u b} ‖ \qquad ( 4 )$$

Referring to Equation 4, H and W are user and item matrices, respectively, the dynamic policy π is a dynamic recommendation policy equal to HW, R is a user-item rating at the edge device, and the static policy π_{hub}=R_{hub}. Comparing Equation 1 with Equation 4, the base objective function ƒ(π)=∥HW−R∥, g is an identity matrix for explicit advice from the static policy π_{hub} with regard to ratings, and the distance function D=∥HW−R_{hub}∥ is a Euclidean norm. In some cases, the objective function according to Equation 4 is implemented in a dynamic machine learning model as described with reference to FIGS. 1-2, and 4 that operates as a score-based recommender system (e.g., a recommender system that scores available content based on user relevance). In some cases, the dynamic policy π of Equation 4 is a deterministic policy. In some cases, g is a scoring of the dynamic policy π and the static policy π_{hub} on a selection of content for implicit advice from the static policy π_{hub}.

According to some aspects, the edge device updates the edge device by maximizing the objective function computed according to Equation 4. An example of an alternating least squares algorithm for updating the dynamic machine learning model using collaborative filtering with distillation is described with reference to FIG. 13.

In some examples, the edge device recommends content to a user based on the dynamic machine learning model. For example, in some cases, the dynamic machine learning model is updated based on the objective function to predict a content recommendation for a user. In some cases, the dynamic machine learning model provides the content recommendation for the user to a content component as described with reference to FIG. 2. In some cases, the edge device generates the content or retrieves the recommended content from a database (such as the database described with reference to FIG. 1) in response to the content recommendation, and provides the recommended content to the user.

In some cases, the training data includes user interaction data with the content. For example, in some cases, the user provides a rating for the recommended content to the edge device in response to receiving the content from the edge device, where the user interaction data includes the rating. In some cases, the user interaction data includes data corresponding to a relationship between the user and the recommended content (such as a click of a hyperlink corresponding to the recommended content, a view time of the recommended content, a number of downloads of the recommended content, a share of the recommended content, etc.).

In some examples, the edge device transmits the training data from the edge device to the hub device. In some examples, the hub device trains the static machine learning model based on the training data from the edge device. For example, the hub device updates the static machine learning model based on the training data received from the edge device.

According to some aspects, an additional edge device collects additional training data at the additional edge device. In some cases, the additional edge device is a similar device to the edge device. In some cases, the additional edge device is located in a different geographical region than the edge device. In some cases, the additional edge device receives additional user interaction data from an additional user device as described with reference to FIG. 4 and provides the additional user interaction data to the hub device as the additional training data. In some cases, the hub device trains the static machine learning model based on the additional training data.

According to some aspects, learning a dynamic machine learning model on the edge device with advice from the static machine learning model is less costly compared to a conventional centralized machine learning recommendation model. In some cases, the communication cost can be modeled over a granularity of interactions generated from user devices. For example, in a comparative case where each record corresponds to an interaction between a user device and the edge device, and if every user device has to communicate to the hub device via an edge device, then the cost of communication is:

$${\sum }_{i = 1}^{d} ( {C}_{{E}_{j} , {D}_{i}} + {C}_{{E}_{j} , H} ) \qquad ( 5 )$$

Referring to Equation 5, C_{E}_{ⱼ}_{,D}_{ᵢ} is a cost of sending one interaction from user device Dᵢ to nearest edge device Eⱼ, and C_{E}_{ⱼ}_{,H} is the cost of transferring one record from edge device Eⱼ to hub device H.

According to some aspects, however, a small machine learning model is sent only periodically to the edge device for bootstrapping the dynamic machine learning model. In this case, the cost of communication is given by:

$${\sum }_{j = 1}^{m} ( ( d / z ) {C}_{{E}_{j} , H}^{M} + {\sum }_{i = 1}^{d} {C}_{{E}_{j} , {D}_{i}} ) \qquad ( 6 )$$

Referring to Equation 6, C_{E}_{ⱼ}_{,H}^{M} denotes a cost of transferring the static machine learning model from hub device H to edge device Eⱼ, and z denotes an activity.

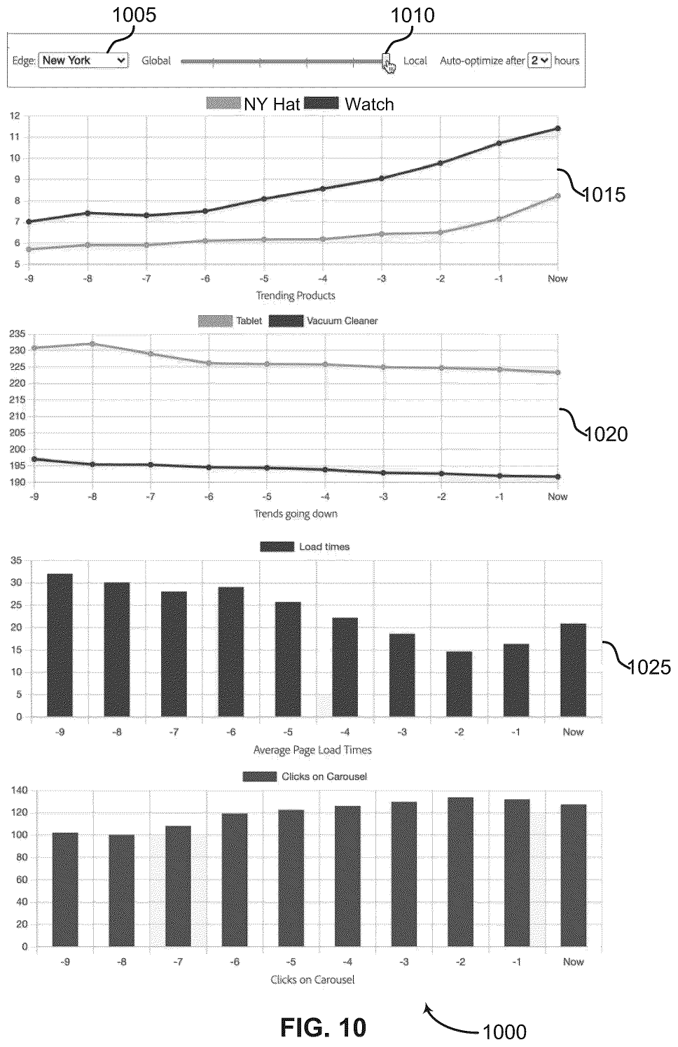

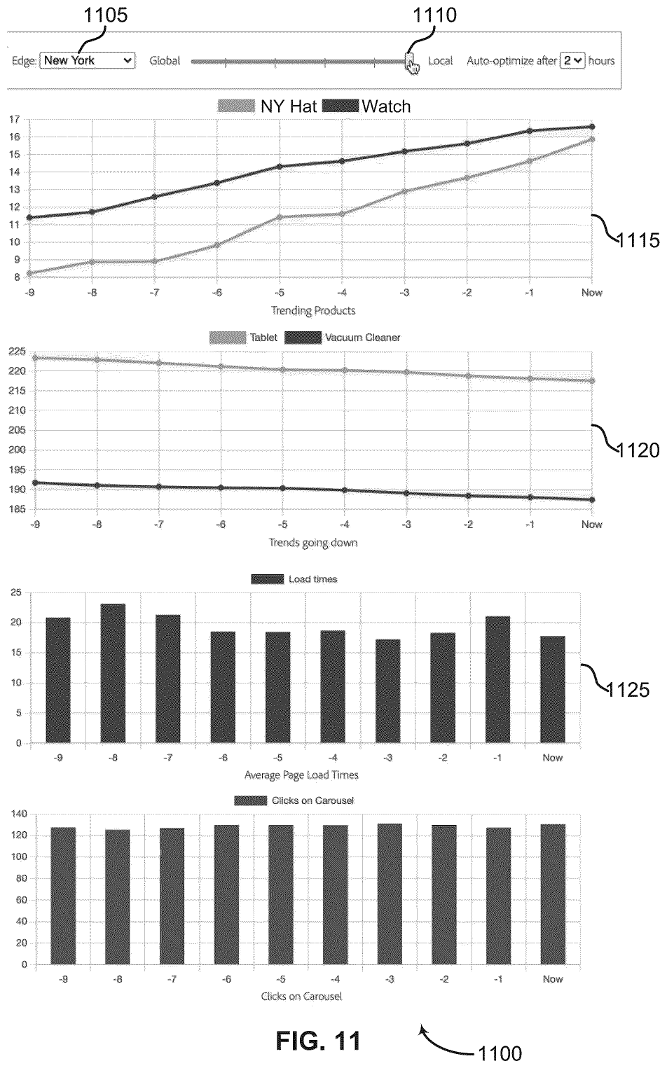

FIG. 9 shows an example of a dashboard 900 according to aspects of the present disclosure. Dashboard 900 is an example of, or includes aspects of, the corresponding element described with reference to FIGS. 10 and 11. In one aspect, dashboard 900 includes region selection menu 905, scaling slider 910, trending products panel 915, receding trends panel 920, and average page load times panel 925. Region selection menu 905 is an example of, or includes aspects of, the corresponding element described with reference to FIGS. 10 and 11. Scaling slider 910 is an example of, or includes aspects of, the corresponding element described with reference to FIGS. 10 and 11. Trending products panel 915 is an example of, or includes aspects of, the corresponding element described with reference to FIGS. 10 and 11. Receding trends panel 920 is an example of, or includes aspects of, the corresponding element described with reference to FIGS. 10 and 11. Average page load times panel 925 is an example of, or includes aspects of, the corresponding element described with reference to FIGS. 10 and 11.

FIG. 10 shows an example of a dashboard 1000 according to aspects of the present disclosure. Dashboard 1000 is an example of, or includes aspects of, the corresponding element described with reference to FIGS. 9 and 11. In one aspect, dashboard 1000 includes region selection menu 1005, scaling slider 1010, trending products panel 1015, receding trends panel 1020, and average page load times panel 1025. Region selection menu 1005 is an example of, or includes aspects of, the corresponding element described with reference to FIGS. 9 and 11. Scaling slider 1010 is an example of, or includes aspects of, the corresponding element described with reference to FIGS. 9 and 11. Trending products panel 1015 is an example of, or includes aspects of, the corresponding element described with reference to FIGS. 9 and 11. Receding trends panel 1020 is an example of, or includes aspects of, the corresponding element described with reference to FIGS. 9 and 11. Average page load times panel 1025 is an example of, or includes aspects of, the corresponding element described with reference to FIGS. 9 and 11.

FIG. 11 shows an example of a dashboard 1100 according to aspects of the present disclosure. Dashboard 1100 is an example of, or includes aspects of, the corresponding element described with reference to FIGS. 9 and 10. In one aspect, dashboard 1100 includes region selection menu 1105, scaling slider 1110, trending products panel 1115, receding trends panel 1120, and average page load times panel 1125. Region selection menu 1105 is an example of, or includes aspects of, the corresponding element described with reference to FIGS. 9 and 10. Scaling slider 1110 is an example of, or includes aspects of, the corresponding element described with reference to FIGS. 9 and 10. Trending products panel 1115 is an example of, or includes aspects of, the corresponding element described with reference to FIGS. 9 and 10. Receding trends panel 1120 is an example of, or includes aspects of, the corresponding element described with reference to FIGS. 9 and 10. Average page load times panel 1125 is an example of, or includes aspects of, the corresponding element described with reference to FIGS. 9 and 10.

Referring to FIGS. 9-11, according to some aspects, dashboards 900, 1000, and 1100 are time-lapsed views of graphical user interfaces provided by an edge device as described with reference to FIGS. 1-2 and 4 for a third-party user (such as a content provider) to view and interact with information relating to the dynamic machine learning model via a user device.

For example, region selection menu 905 shows a drop-down menu for selecting various edge devices and dynamic machine learning models corresponding to various regions. Region selection menu 1005 and region selection menu 1105 show a selection of an edge device located in New York.

Scaling sliders 910, 1010, and 1110 offer the third-party user a mechanism for adjusting the scaling parameter described with reference to FIG. 8, such that a degree of divergence between the dynamic machine learning model and the static machine learning model is controlled. As shown by comparing trending products panels 915, 1015, and 1115, and receding trends panels 920, 1020, and 1120, different products trend based on a selection of an edge device, and regional trends increase over time as the scaling parameter is maintained at a “local” setting. Furthermore, as shown by average page load times panels 925, 1025, and 1125, average page loading times decrease over time as the scaling parameter is maintained at a “local” setting.

FIG. 12 shows an example of an algorithm 1200 for training a reinforcement learning model according to aspects of the present disclosure. Referring to FIG. 12, algorithm 1200 is a deep deterministic policy gradient (DDPG) with distillation algorithm. DDPG is an algorithm that concurrently learns a Q-function using the Bellman equation and a policy using the Q-function. Distillation refers to a technique for compressing knowledge from ensemble teacher machine learning models into a student machine learning model. The boxed portions of lines 15-19 and 23 of algorithm 1200 indicate an inclusion of a dynamic recommendation policy π, a static recommendation policy π_{hub}, a scoring function g, and a penalty term ∈ *g in algorithm 1200.

For example, in some cases, the state s of a dynamic machine learning model as described with reference to FIG. 5 is transformed by an edge device as described with reference to FIGS. 1-2 and 4 to a state s_{hub} of the static machine learning model by an embedding function ε. Then a distance function g as described with reference to FIG. 8 is determined as a scoring function. Finally, an actor of the dynamic machine learning model is updated using a sample policy gradient based on a penalty term ∈*g as described with reference to FIG. 8.

FIG. 13 shows an example of an algorithm 1300 for training a collaborative filtering model according to aspects of the present disclosure. Referring to FIG. 13, algorithm 1300 is an alternating least squares (ALS) algorithm for training a collaborative filtering machine learning model with distillation. ALS is a matrix factorization algorithm that uses L2 regularization and alternatively minimizes two loss functions by first holding a user matrix fixed and running a gradient descent with an item matric, and then holding the item matrix fixed and running a gradient descent with the user matrix.

In some cases, matrix factorization refers to a decomposition of a rating matrix into the product of the user matrix and the item matrix, where the rating matric includes rows representing users, columns representing items (e.g., content), and entries representing ratings, the user matrix includes rows representing users and columns representing latent factors, and the item matrix includes rows representing latent factors and columns representing items (e.g., content). By learning to factorize the rating matrix into user and content representations, the dynamic machine learning model learns to predict personalized content to be provided to a user.

The boxed portions of lines 6-7 of algorithm 1300 indicate an inclusion of the static policy R_{hub} as described with reference to FIG. 8 and a penalty term ∈(WᵢHⱼ−R_{i,j}^{hub}) as described with reference to FIG. 8. By including the penalty term penalty term E(WᵢHⱼ−R_{i,j}^{hub}) in the error function error, embodiments of the present disclosure provide for a scaled influence of the static machine learning model on a dynamic machine learning model during a training process of the dynamic machine learning model as described with reference to FIG. 6.

### Content Recommendation

A method for distributed machine learning is described with reference to FIG. 14. One or more aspects of the method include obtaining user interaction data for a user; computing a policy function of a dynamic machine learning model based on the user interaction data, wherein the dynamic machine learning model is trained based on a relationship between the dynamic machine learning model and a static machine learning model from a hub device; and recommending content to the user based on the policy function.

Some examples of the method further include identifying a state based on the user interaction data, wherein the policy function takes the state as input. In some aspects, the policy function comprises a neural network trained using reinforcement learning. In some aspects, the policy function comprises a user matrix and an item matrix trained using collaborative filtering.

FIG. 14 shows an example of a method 1400 for recommending content to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1405, the system obtains user interaction data for a user. In some cases, the operations of this step refer to, or may be performed by, an edge device as described with reference to FIGS. 1, 2, and 4.

At operation 1410, the system computes a policy function of a dynamic machine learning model based on the user interaction data, where the dynamic machine learning model is trained based on a relationship between the dynamic machine learning and a static machine learning model from a hub device. In some cases, the operations of this step refer to, or may be performed by, an edge device as described with reference to FIGS. 1, 2, and 4.

In some aspects, the policy function includes a neural network trained using reinforcement learning. In some examples, the edge device identifies a state based on the user interaction data. In some cases, the policy function takes the state as input. In some aspects, the policy function includes a user matrix and an item matrix trained using collaborative filtering.

At operation 1415, the system recommends content to the user based on the policy function. In some cases, the operations of this step refer to, or may be performed by, an edge device as described with reference to FIGS. 1, 2, and 4.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for distributed machine learning, comprising:
obtaining, by an edge device, a static machine learning model from a hub device;
computing, by the edge device, an objective function for a dynamic machine learning model based on a relationship between the dynamic machine learning model and the static machine learning model; and
updating, by the edge device, the dynamic machine learning model based on the objective function.

2. The method of claim 1, further comprising:
computing, by the edge device, a distance function between the dynamic machine learning model and the static machine learning model, wherein the objective function is based on the distance function.

3. The method of claim 2, further comprising:
scaling, by the edge device, the distance function by on a scaling parameter to obtain a penalty term, wherein the objective function includes the penalty term.

4. The method of claim 2, further comprising:
identifying, by the edge device, a static policy function for the static machine learning model; and
identifying, by the edge device, a dynamic policy function for the dynamic machine learning model, wherein the distance function is computed between the dynamic policy function and the static policy function.

5. The method of claim 1, further comprising:
initializing, by the edge device, the dynamic machine learning model based on the static machine learning model.

6. The method of claim 1, further comprising:
collecting, by the edge device, training data at the edge device, wherein the edge device is updated based on the training data.

7. The method of claim 6, further comprising:
recommending, by the edge device, content to a user based on the dynamic machine learning model, wherein the training data comprises user interaction data with the content.

8. The method of claim 6, further comprising:
transmitting the training data from the edge device to the hub device; and
training, by the hub device, the static machine learning model based on the training data from the edge device.

9. The method of claim 8, further comprising:
collecting additional training data at an additional edge device; and
transmitting the additional training data from the additional edge device to the hub device, wherein the static machine learning model is trained based on the additional training data.

10. The method of claim 1, wherein:
the static machine learning model and the dynamic machine learning model comprise reinforcement learning models.

11. The method of claim 1, wherein:
the static machine learning model and the dynamic machine learning model comprise collaborative filtering models.

12. A method for distributed machine learning, comprising:
obtaining, by an edge device, user interaction data for a user;
computing, by the edge device, a policy function of a dynamic machine learning model based on the user interaction data, wherein the dynamic machine learning model is trained based on a relationship between the dynamic machine learning and a static machine learning model from a hub device; and
recommending, by the edge device, content to the user based on the policy function.

13. The method of claim 12, further comprising:
identifying, by the edge device, a state based on the user interaction data, wherein the policy function takes the state as input.

14. The method of claim 12, wherein:
the policy function comprises a neural network trained using reinforcement learning.

15. The method of claim 12, wherein:
the policy function comprises a user matrix and an item matrix trained using collaborative filtering.

16. A system for distributed, comprising:
an edge device including a memory and a processor, wherein the processor is configured to:
obtain a static machine learning model from a hub device;
compute an objective function for a dynamic machine learning model based on a relationship between the dynamic machine learning model and the static machine learning model; and
update the dynamic machine learning model based on the objective function.

17. The system of claim 16, wherein:
the system further comprises the hub device, and the hub device is configured to train the static machine learning model.

18. The system of claim 16, the system further comprising:
an additional edge device configured to train an additional dynamic machine learning model based on the static machine learning model.

19. The system of claim 16, wherein:
the dynamic machine learning model comprises a reinforcement learning model.

20. The system of claim 16, wherein:
the dynamic machine learning model comprises a collaborative filtering model.
